(19) United States
(12) Patent Application Publication
(10) Pub. No.: US 2023/0213716 A1
(43) Pub. Date: Jul. 6, 2023

(54) RIBBED AND GROOVED SHEATH FOR OPTICAL FIBER CABLE

(71) Applicant: Sterlite Technologies Limited, Gurugram (IN)

(72) Inventors: Sourabh Singh, Gurugram (IN); Kawarpreet Singh, Gurugram (IN)

(73) Assignee: Sterlite Technologies Limited, Gurugram (IN)

(21) Appl. No.: 17/700,480

(22) Filed: Mar. 21, 2022

(30) Foreign Application Priority Data
Dec. 30, 2021 (IN) 202111061736

(51) Int. Cl. G02B 6/44

(52) U.S. Cl. CPC G02B 6/443

(57) ABSTRACT

The present disclosure provides ribbed and grooved sheath for optical fiber cables. An optical fiber cable (100) comprises one or more optical transmission elements (118) and a sheath (102) surrounding the one or more optical transmission elements (118). An outer surface of the sheath (102) has a plurality of ribs (104, 106, 108) and a plurality of grooves (110, 112) such that at least one groove has unequal groove width and/or at least one rib has unequal rib width. The plurality of ribs (104, 106, 108) is continuous and parallel on the outer surface. Alternatively, the plurality of ribs (104, 106, 108) is discontinuous.

### TECHNICAL FIELD

The present disclosure relates to an optical fiber cable, more particularly, relates to a ribbed and grooved sheath for optical fiber cables.

### BACKGROUND

Optical fiber cables are a critical component of a modern communications network across the globe. To meet the increasing data and bandwidth demands, installation of the optical fiber cables at a rapid pace becomes essential. The optical fiber cables for telecommunications application are installed in ducts, wherein the installation of the optical fiber cables in the ducts is mostly performed using a blowing method. The blowing method enables installation of the optical fiber cables using pressurized air combined with an additional mechanical pushing force such as hydrostatic forces and viscous forces.

However, blowing of the optical fiber cables in the ducts is dependent on a plurality of factors such as mass/weight of the optical fiber cables, friction, stiffness, and the like. For example, the conventional structures of sheaths of the optical fiber cables make them inefficient to allow pressurized air to blow the optical fiber cables in the pre-installed ducts as well as in the conventional optical fiber cables, drag/viscous force between the conventional structures of the sheaths of the optical fiber cables and the pre-installed ducts is less, thereby restricting the scope of blowing. Further, the conventional optical fiber cables are heavy in weight, which also restricts the scope of blowing.

One way to address the aforesaid drawbacks is providing corrugated type sheaths. In the same context, a prior art reference “CN111474654B” teaches an optical fiber cable having grooves with different location structure for identification of slots. Another prior art reference “US10094995B2” teaches a cable sheath with two diagonally opposite ribs and embedded strength members. However, the optical fiber cables disclosed in the prior arts still are limited by high coefficient of friction, high stiffness as well as heavy-weight, thereby requiring high pushing force during blowing. Therefore, a solution is needed to overcome the above-stated drawbacks and to make an optical fiber cable to have a better blowing performance.

### OBJECT OF THE DISCLOSURE

A principal object of the present disclosure is to provide a ribbed and grooved sheath for optical fiber cables.

Another object of the present disclosure is to provide a ribbed and grooved cable having improved blowing performance.

Yet another object of the present disclosure is to provide the ribbed and grooved cable that has high resistance against crush and is light weight.

### SUMMARY

Accordingly, the present disclosure provides ribbed and grooved sheath for optical fiber cables. An optical fiber cable comprises one or more optical transmission elements and a sheath surrounding the one or more optical transmission elements. The optical fiber cable is capable of being blown to a distance of at least 500 m in a duct with an average speed of at least 40 meter per minute blown with an air pressure of less than 15 bar with a duct fill ratio of 35% to 65%. An outer surface of the sheath has a plurality of ribs and a plurality of grooves such that at least one groove has unequal groove width and/or at least one rib has unequal rib width. The plurality of ribs is continuous and parallel on the outer surface. Alternatively, the plurality of ribs is discontinuous. A rib width is measured at bottom and is greater than or equal to 0.15 mm, a groove width is measured at top and greater than or equal to 0.15 mm and a rib height is greater than or equal to 0.15 mm measured radially. A ratio of width of a large sized rib to width of a small sized rib and/or a ratio of width of a large sized groove to width of a small sized groove is 1.2 or more. Further, the sheath has a thickness of 1.5 mm to 3 mm including the rib height.

These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF FIGURES

The invention is illustrated in the accompanying drawings, throughout which like reference letters indicate corresponding parts in the drawings. The invention herein will be better understood from the following description with reference to the drawings, in which:

FIG. 1 illustrates an example optical fiber cable having semi-circular protrusions (ribs) on a sheath and FIG. 2 depicts the sheath.

FIG. 3 illustrates an alternative sheath for an optical fiber cable.

FIG. 4 illustrates a triangular shaped sheath for an optical fiber cable.

FIG. 5 depicts a flower shaped sheath for an optical fiber cable.

FIG. 6 illustrates a top view of a sheath depicting supressed regions (dimples) in the sheath.

FIG. 7 illustrates an example optical fiber cable having rectangular protrusions (ribs) on a sheath and FIG. 8 depicts the sheath.

FIG. 9 illustrates an example design of a sheath of an optical fiber cable having continuous axial ribs.

FIG. 10 illustrates an example design of a sheath of an optical fiber cable having discontinuous axial ribs.

FIG. 11 illustrates an example design of a sheath of an optical fiber cable having continuous radial ribs.

FIG. 12 illustrates an example design of a sheath of an optical fiber cable having discontinuous radial ribs.

FIG. 13 illustrates an example design of a sheath of an optical fiber cable having continuous helical ribs.

FIG. 14 illustrates an example design of a sheath of an optical fiber cable having discontinuous helical ribs.

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in detail so as not to unnecessarily obscure aspects of the invention.

Furthermore, it will be clear that the invention is not limited to these alternatives only. Numerous modifications, changes, variations, substitutions and equivalents will be apparent to those skilled in the art, without parting from the scope of the invention.

The accompanying drawings are used to help easily understand various technical features and it should be understood that the alternatives presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Unlike conventional sheath designs having smooth surface that are limited by low viscous force between the sheath and air and high stiffness during blowing process as well as are heavy-weighted, the present disclosure provides alternate sheath designs and optical fiber cables formed using the alternate sheath designs that address the aforesaid drawbacks. The optical fiber cables with lower weight and higher stiffness as well as with higher viscous drag force between the air and the sheaths blow to longer distances as compared to the optical fiber cables with the conventional sheath designs.

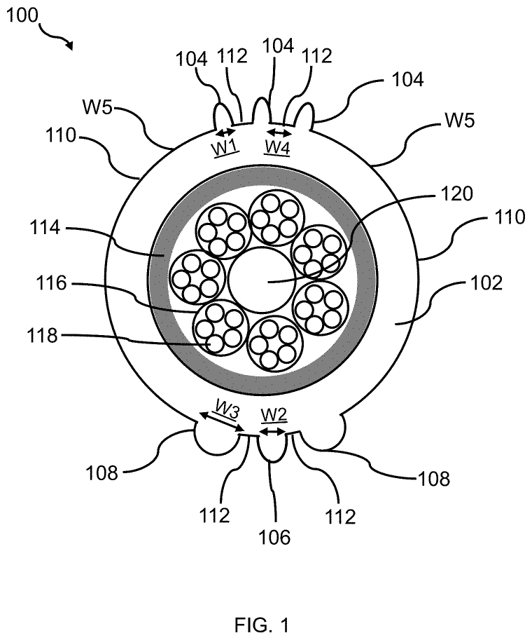

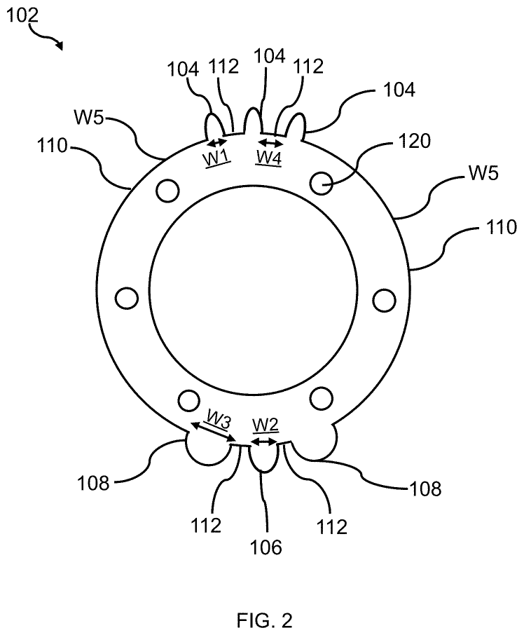

Accordingly, FIG. 1 illustrates an example optical fiber cable 100havingsemi-circular protrusions (ribs) on a sheath 102 and FIG. 2 depicts the sheath 102.

The optical fiber cable 100 may include the sheath 102, a first layer 114, one or more fiber encapsulating elements 116 and one or more optical transmission elements 118 and one or more strength members 120.

The sheath 102 (as shown in FIG. 1 and FIG. 2) may be an outer layer of the optical fiber cable 100. The sheath 102 may be defined by an inner surface and an outer surface. The outer surface of the sheath 102 may have a plurality of ribs 104, 106, 108 and a plurality of grooves 110, 112.

The plurality of ribs 104, 106, 108 and the plurality of grooves 110, 112 may be formed in such a way that at least one groove has unequal groove width and/or at least one rib has unequal rib width.For example, ribs 104 are small sized ribs having a rib width W1 (smaller width), a rib 106 is a medium sized rib having a rib width W2 (medium width) and ribs 108 are large sized ribs having a rib width W3 (larger width).As shown in FIG. 1 and FIG. 2, the rib width W1, the rib width W2 and the rib width W3 are different due to different sizes of the plurality of ribs 104, 106, 108. Similarly, the plurality of grooves may have different widths. For example, grooves 112 are small sized grooves having a groove width W4 (smaller width) and grooves 110 are large sized grooves having a groove width W5 (larger width).As shown in FIG. 1 and FIG. 2, the groove width W4 and the groove width W5 are different due to different sizes of the plurality of grooves 110, 112.A ratio of width of a large sized rib (biggest rib with width W3) to width of a small sized rib (smallest rib with width W1) may be 1.2 or more. Similarly, a ratio of width of a large sized groove (biggest groove with width W5) to width of a small sized groove (smallest groove with width W4) may be 1.2 or more.

Herein, the width may be measured as a bottom width for the plurality of ribs 104, 106, 108 and a top width for the plurality of grooves 110, 112. In case of a semi-circular shaped rib (as shown in FIG. 1 and FIG. 2), the width may be width of bottom of the rib(s) which is substantially equal to diameter of the semi-circle.

The (rib) width, measured at the bottom, of each of the plurality of ribs 104, 106, 108 may be greater than or equal to 0.15 mm as below 0.15 mm tool design and manufacturing will become difficult and error tolerance will be significantly high. Further, the (groove) width, measured at the top, of each of the plurality of grooves 110, 112 may be greater than or equal to 0.15 mm.

The plurality of ribs 104, 106, 108 may be extruded/arranged in any order. For example, the small sized ribs, medium sized ribs and the large sized ribs may be extruded alternately. The plurality of ribs 104, 106, 108 may be characterized by a rib height or bottom depth. The rib height, measured radially, may be greater than or equal to 0.15 mm as below 0.15 mm tool design and manufacturing will become difficult and error tolerance will be significantly high. The plurality of ribs 104, 106, 108 may be continuous and parallel. Alternatively, the plurality of ribs 104, 106, 108 may be discontinuous and parallel. The continuous ribs are continuous protrusion over the entire length of the sheath. For example, if a rib has a flower shaped (explained below) protrusion at one end, the protrusion extends along the entire length of the optical fiber cable. Contrarily, the discontinuous ribs are discontinuous protrusion along the entire length of the sheath (explained below).

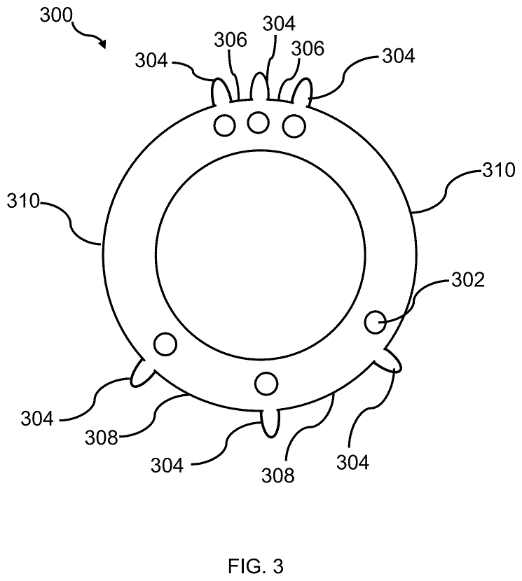

It may be noted that the present disclosure is not limited to the aforesaid arrangements, dimensions and designs of ribs and grooves. It is possible to extrude the sheath 102 to have various other arrangements, dimensions and designs of ribs and grooves. Non limiting example may be one rib and/or groove may have different width or three ribs and/or grooves may have different widths or a greater number of ribs and/or grooves may have different widths or all the ribs and/or grooves may have unequal widths. The plurality of ribs may have various shapes such as, but not limited to, shapes of arc, square, rectangular, tapered, triangular, flower and at least two ribs and/or at least two grooves may have a similar shape or a different shape. Various example arrangements, shapes and designs of ribs and grooves are explained in conjunction with FIG. 3 to FIG. 16.

The sheath 102 may be characterized by a thickness, wherein the sheath may have the thickness in a range of 1.5 mm to 3 mm including the rib heightas below 1.5 mm, manufacturing with embedded strength members will become difficult and the sheath may not possess required mechanical strength and beyond 3 mm, the optical fiber cable 100 will become heavy, which is not suitable for blowing. In general, blowing is a process of installation of an optical fiber cable into a pre-installed duct. The blowing is performed by injecting pressurized air in an inlet of the pre-installed duct before the optical fiber cable is pushed into the pre-installed duct, where the pressurized air flows at high speed through the pre-installed duct and along the optical fiber cable. Basically, in blowing, an optical fiber cable is carried forward by pressurized air into the pre-installed duct via hydrostatic forces and viscous forces.

The sheath 102 may be extruded over the one or more strength members 120 as shown in FIG. 2. Usually, sheathing (extrusion) is done at a high temperature (preferably more than 100° C.). The sheathing is a process of squeezing a molten sheathing material through a funnel of a die as the core runs through the center. The sheathing material for the sheath may include, but not limited to, polyvinylchloride, polyethylene (such as High Density Poly Ethylene (HDPE),

Medium Density Poly Ethylene, and Low Density Poly Ethylene), polyurethane, thermoplastic rubber/elastomer, thermoplastic chlorinated polyethylene or combination thereof.

The one or more strength members 120 may provide mechanical strength and stiffness to the optical fiber cable 100. The one or more strength members 120 may provide predictable break load and excellent crush protection/resistance performance. The crush resistance is an ability of a cable to withstand and/or recover from the effects of a compressive force. The one or more strength members 120 may be made of, but not limited to, FRP (Fiber Reinforced Plastic), ARP (Aramid Reinforced Plastic) or any other suitable dielectric/strength material. The one or more strength members 120 may have a round shape, a flat shape or any other suitable shape. The one or more strength members 120 may be coated with EAA (Ethylene Acrylic Acid) or EVA (Ethylene-Vinyl Acetate) coating for better adhesion with the sheath 102, i.e., to enhance the adhesion of the one or more strength members 120 with the sheath 102. Alternatively, the one or more strength members 120 may be placed at center of the optical fiber cable100 instead of embedding in the sheath 102, thus, may be referred to as a central strength member (as shown in FIG. 1).

The sheath 102 may surround the first layer 114. The first layer 114 may be at least one or more layers of binders, aramid yarns, glass roving yarns, water swellable yarns, water blocking tape, metal tape, loose tube, for example. It may be noted the optical fiber cable 100 may contain one or more layers depending upon requirement and implementation. Non-limiting examples of the one or more layers may be water blocking tape, metal tape, dielectric armouring, yarns etc. that are known to a person skilled in the art.

The first layer 114 may surround the one or more fiber encapsulating elements 116. The one or more fiber encapsulating elements 116 may be, but not limited to, buffer tubes, loose tubes, binders, water blocking tapes. The one or more fiber encapsulating elements 116 may also contain at least one of a water swellable yarn and superabsorbent polymer (SAP) powder.

The one or more fiber encapsulating elements 116 may encapsulate the one or more optical transmission elements 118. The one or more optical transmission elements 118 may extend in a longitudinal direction. The one or more optical transmission elements (or interchangeably “optical fibers”) may be present in form of, but not limited to, a group of loose optical fibers, a group (or bundle) of optical fiber ribbons or a stack of optical fiber ribbons, a group of bendable/rollable ribbons, a group of corrugated ribbons, a group of partially bonded optical fiber ribbons, a group of flat ribbons. An optical fiber ribbon bundle is a group of a plurality of optical fiber ribbons arranged together. The optical fiber ribbon includes a number of optical fibers arranged together using a matrix material. Multiple individual optical fiber ribbons are stacked or grouped into a bundle to form the optical fiber ribbon bundle. Furthermore, a partially bonded optical fiber ribbon from the group of intermittently bonded optical fiber ribbons is formed by intermittently bonding the plurality of optical fibers with the matrix material that imparts a bending and rolling capability along a width of the partially bonded optical fiber ribbon.

Generally, an optical fiber refers to a medium associated with transmission of information over long distances in the form of light pulses. The optical fiber uses light to transmit voice and data communications over long distances when encapsulated in a jacket/sheath. The optical fiber may be of ITU. T G.657.A2 category. Alternatively, the optical fiber may be of ITU. T G.657.A1 or G.657.B3 or G.652.D or another suitable category. The ITU. T, stands for International Telecommunication Union-Telecommunication Standardization Sector, is one of the three sectors of the ITU. The ITU is the United Nations specialized agency in the field of telecommunications and is responsible for studying technical, operating and tariff questions and issuing recommendations on them with a view to standardizing telecommunications on a worldwide basis.

The optical fiber may be a bend insensitive fiber that has less degradation in optical properties or less increment in optical attenuation during bending of the optical fiber cable. Thus, the bend insensitive fiber further helps to maintain the optical properties during multiple winding/unwinding operations of the optical fiber cable. The optical fibers may be coloured fiber. The optical fiber may be a single-core optical fiber, a multi-core optical fiber, a single-mode optical fiber, a multimode optical fiber or the like. The single mode optical fiber carries only a single mode of light, and the multimode optical fiber carries multiple modes of light to propagate. The multicore optical fibers comprise of multiple cores as opposed to the single-core optical fiber that comprise only a single core.

FIG. 3 illustrates an alternative sheath 300 for an optical fiber cable. The sheath 300 may comprise a plurality of ribs 304, a plurality of grooves 306, 308, 310and one or more strength members 302 embedded in the sheath 300. Alternatively, the one or more strength members 302 may be a central strength member. The plurality of ribs 304 may have a semi-circular shape. The plurality of ribs 304 may be small sized ribs and may have same width. The plurality of grooves may include small sized grooves 306, medium sized grooves 308 and large sized grooves 310 and may have different widths. The sheath 300 and components of the sheath 300 may have similar details/features/dimensions as explained above in conjunction with FIG. 1 and FIG. 2 and thus, details regarding the same are excluded herein for sake of brevity but should be understood and read in accordance with FIG. 1 and FIG. 2.

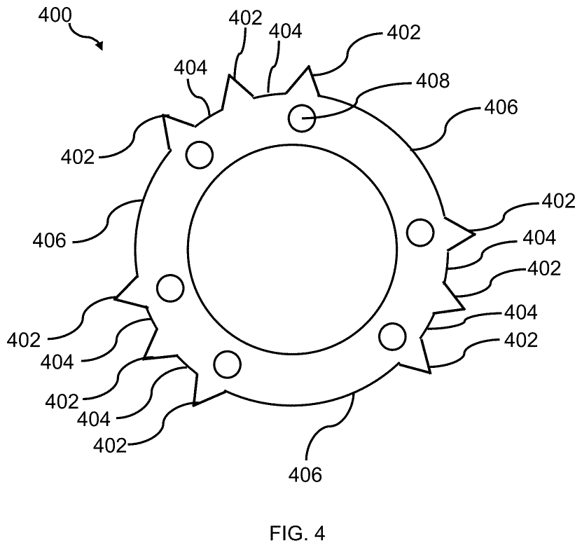

FIG. 4 illustrates an alternative sheath 400 for an optical fiber cable. The sheath 400 may comprise a plurality of ribs 402, a plurality of grooves 404, 406 and one or more strength members 408 embedded in the sheath 400. Alternatively, the one or more strength members 408 may be a central strength member. The plurality of ribs 402 may have a triangular shape. The plurality of ribs 402 may be large sized ribs and may have same width. The plurality of grooves may include small sized grooves 404 and medium sized grooves 406 and may have different widths. The sheath 400 and components of the sheath 400 may have similar details/features/dimensions as explained above in conjunction with FIG. 1 and FIG. 2 and thus, details regarding the same are excluded herein for sake of brevity but should be understood and read in accordance with FIG. 1 and FIG. 2.

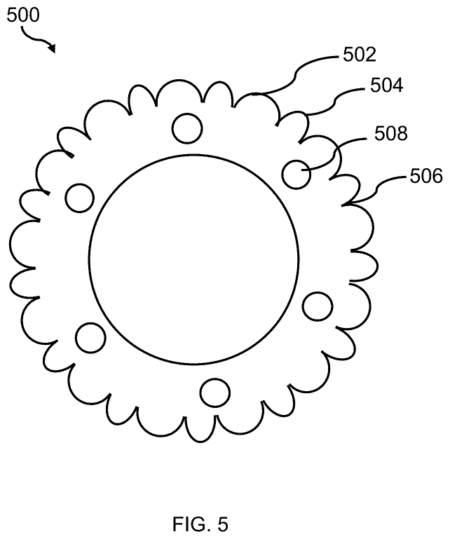

FIG. 5 depicts a flower shaped sheath for an optical fiber cable 500. A sheath 500 (shown in FIG. 5) may include a plurality of ribs 502, 504, a plurality of grooves 506 and one or more strength members 508 embedded in the sheath 500. Alternatively, the one or more strength members 508 may be a central strength member. The plurality of ribs 502, 504 may have a semi-circular shape. The plurality of ribs 502, 504is extruded in such a way that forms a flower shape, wherein the plurality of ribs may have large sized ribs502 with larger width and small sized ribs 504 with smaller width alternately arranged and the plurality of grooves 506 may have same width. The sheath 500 and components of the sheath 500 may have similar details/features/dimensions as explained above in conjunction with FIG. 1 and FIG. 2 and thus, details regarding the same are excluded herein for sake of brevity but should be understood and read in accordance with FIG. 1 and FIG. 2.

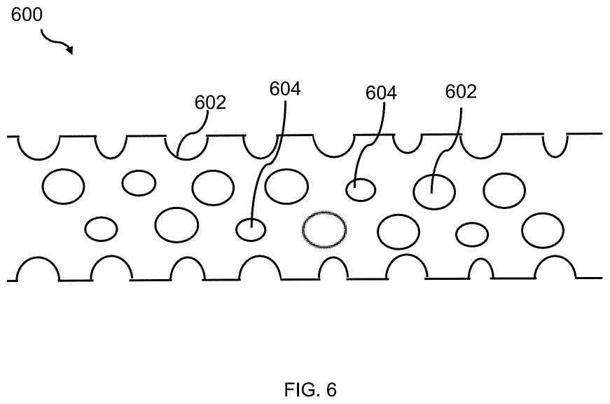

FIG. 6 illustrates a top view of a sheath 600 depicting supressed regions (dimples) in the sheath, wherein the sheath 600 may comprise unequal sized supressed regions 602, 604. Due to the supressed regions, a plurality of grooves formed may be discontinuous grooves. The sheath 600 and components of the sheath 600 may have similar details/features/dimensions as explained above in conjunction with FIG. 1 and FIG. 2 and thus, details regarding the same are excluded herein for sake of brevity but should be understood and read in accordance with FIG. 1 and FIG. 2.

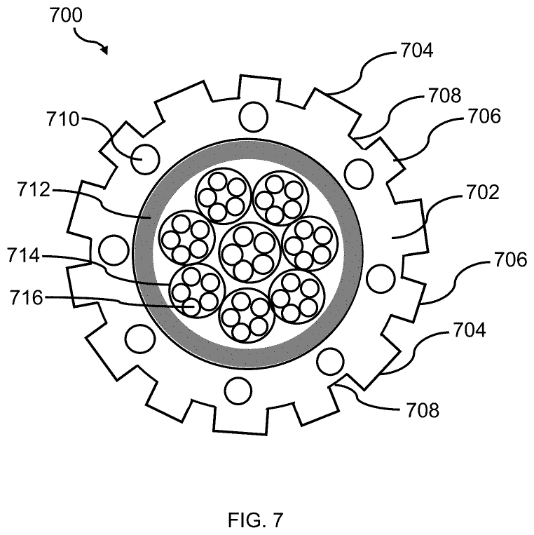

FIG. 7 illustrates an example optical fiber cable 700 having rectangular protrusions (ribs) on a sheath 702 and FIG. 8 depicts the sheath 702. The optical fiber cable 700 may include the sheath 702, a first layer 712, one or more fiber encapsulating elements 714 and one or more optical transmission elements 716 and one or more strength members 710.

The sheath 702 may include a plurality of ribs 704, 706 and a plurality of grooves 708 that may be formed in such a way that at least one groove has unequal groove width and/or at least one rib has unequal rib width. For example, ribs 706 are small sized ribs having a rib width W6 (smaller width) and ribs 704 are large sized ribs having a rib width W7 (larger width). As shown in FIG. 7 and FIG. 8, the rib width W6 and the rib width W7 are different due to different sizes of the plurality of ribs 704, 706. Similarly, the plurality of grooves 708 may or may not have different widths. Herein, the plurality of grooves 708 may be defined by a groove width W8.A ratio of width of a large sized rib (biggest rib with width W7) to width of a small sized rib (smallest rib with width W6) may be 1.2 or more.

It may be noted that the sheath 702, the optical fiber cab1e700and components of the optical fiber cab1e700 may have similar details/features/dimensions such as height, thickness, material or the like as explained above in conjunction with FIG. 1 and FIG. 2 and thus, details regarding the same are excluded herein for sake of brevity but should be understood and read in accordance with FIG. 1 and FIG. 2.

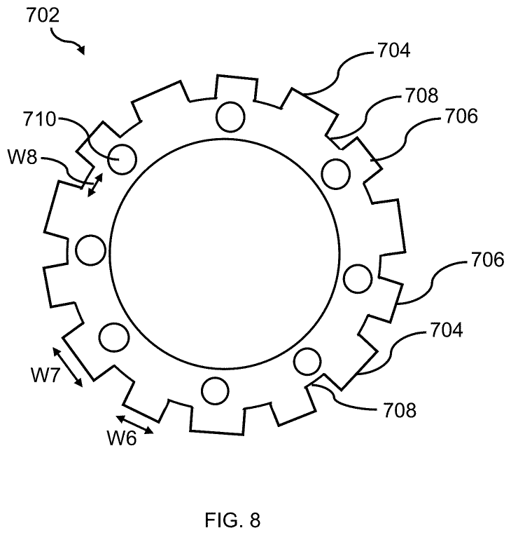

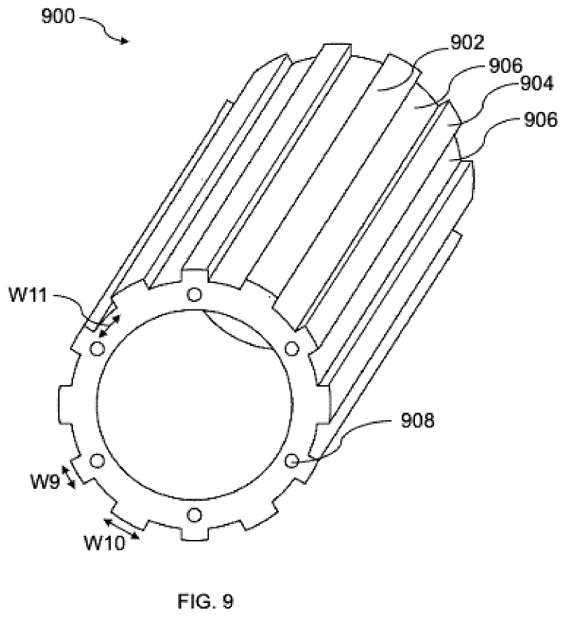

FIG. 9 illustrates an example design of a sheath 900 of an optical fiber cable having continuous axial (longitudinal) ribs. The sheath 900 may have a plurality of ribs 902, 904 and a plurality of grooves906 formed axially and one or more strength members 908. The plurality of ribs 902, 904 and the plurality of grooves 906 may be formed in such a way that at least one groove has unequal groove width and/or at least one rib has unequal rib width. For example, ribs 904 are small sized ribs having a rib width W9 (smaller width) and ribs 902 are large sized ribs having a rib width W10 (larger width). As shown in FIG. 9, the rib width W9 and the rib width W10 are different due to different sizes of the plurality of ribs 902, 904. Similarly, the plurality of grooves 906 may or may not have different widths. Herein, the plurality of grooves 906 may be defined by a groove width W11. A ratio of width of a large sized rib (biggest rib with width W10) to width of a small sized rib (smallest rib with width

W9) may be 1.2 or more. The plurality of ribs 902, 904 may be continuous and parallel. The sheath 900 and components of the sheath 900 may have similar details/features/dimensions as explained above in conjunction with FIG. 1 and FIG. 2 and thus, details regarding the same are excluded herein for sake of brevity but should be understood and read in accordance with FIG. 1 and FIG. 2.

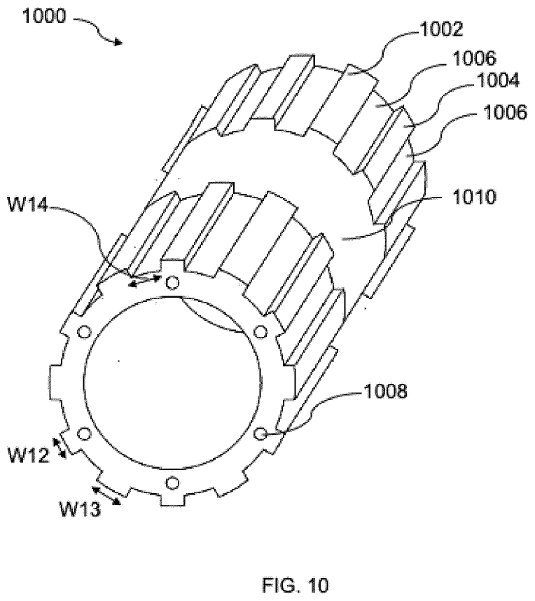

FIG. 10 illustrates an example design of a sheath 1000 of an optical fiber cable having discontinuous axial ribs. The sheath 1000 may have a plurality of ribs 1002, 1004 and a plurality of grooves 1006 formed axially and one or more strength members 1008. The plurality of ribs 1002, 1004 and the plurality of grooves 1006 may be formed in such a way that at least one groove has unequal groove width and/or at least one rib has unequal rib width. For example, ribs 1004 are small sized ribs having a rib width W12 (smaller width) and ribs 1002 are large sized ribs having a rib width W13 (larger width). As shown in FIG. 10, the rib width W12 and the rib width W13 are different due to different sizes of the plurality of ribs 1002, 1004. Similarly, the plurality of grooves 1006 may or may not have different widths. Herein, the plurality of grooves 1006 may be defined by a groove width W14. A ratio of width of a large sized rib (biggest rib with width W13) to width of a small sized rib (smallest rib with width W12) may be 1.2 or more. The plurality of ribs 1002, 1004 may be discontinuous (discontinuity is depicted by 1010) and parallel. The sheath 1000 and components of the sheath 1000 may have similar details/features/dimensions as explained above in conjunction with FIG. 1 and FIG. 2 and thus, details regarding the same are excluded herein for sake of brevity but should be understood and read in accordance with FIG. 1 and FIG. 2.

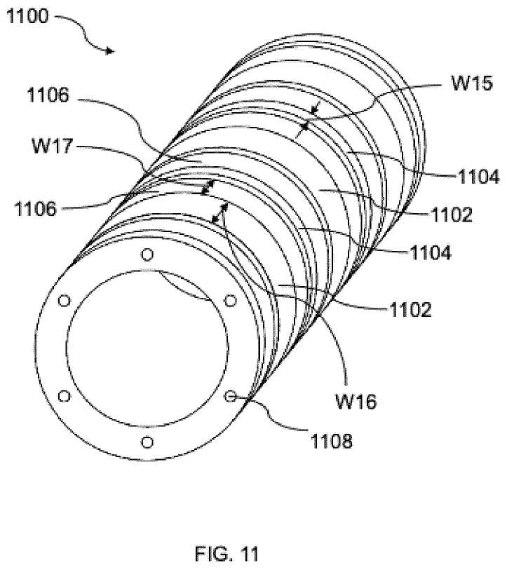

FIG. 11 illustrates an example design of a sheath 1100 of an optical fiber cable having continuous radial ribs. The sheath 1100 may have a plurality of ribs 1102, 1104 and a plurality of grooves 1106 formed radially and one or more strength members 1108. The plurality of ribs 1102, 1104 and the plurality of grooves 1106 may be formed in such a way that at least one groove has unequal groove width and/or at least one rib has unequal rib width. For example, ribs 1104 are small sized ribs having a rib width W15 (smaller width) and ribs 1102 are large sized ribs having a rib width W16 (larger width). As shown in FIG. 11, the rib width W15 and the rib width W16 are different due to different sizes of the plurality of ribs 1102, 1104. Similarly, the plurality of grooves 1106 may or may not have different widths. Herein, the plurality of grooves 1106 may be defined by a groove width W17. A ratio of width of a large sized rib (biggest rib with width W16) to width of a small sized rib (smallest rib with width W15) may be 1.2 or more. The plurality of ribs 1102, 1104 may be continuous and parallel. The sheath 1100 and components of the sheath 1100 may have similar details/features/dimensions as explained above in conjunction with FIG. 1 and FIG. 2 and thus, details regarding the same are excluded herein for sake of brevity but should be understood and read in accordance with FIG. 1 and FIG. 2.

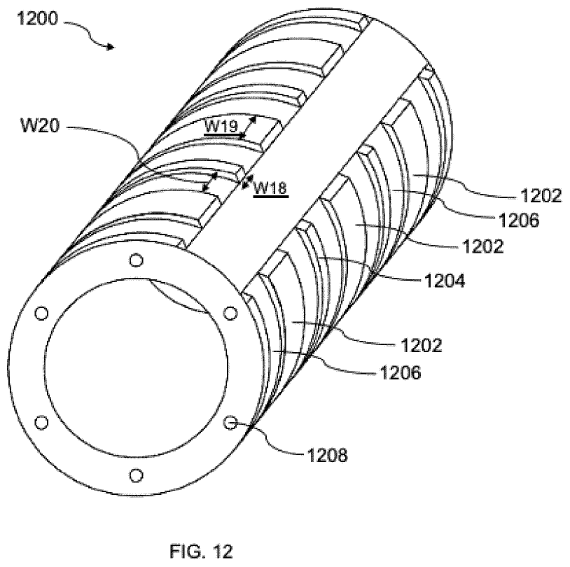

FIG. 12 illustrates an example design of a sheath1200 of an optical fiber cable having discontinuous radial ribs. The sheath 1200 may have a plurality of ribs 1202, 1204 and a plurality of grooves 1206 formed radially and one or more strength members 1208. The plurality of ribs 1202, 1204 and the plurality of grooves 1206 may be formed in such a way that at least one groove has unequal groove width and/or at least one rib has unequal rib width. For example, ribs 1204 are small sized ribs having a rib width W18 (smaller width) and ribs 1202 are large sized ribs having a rib width W19 (larger width). As shown in FIG. 12, the rib width W18 and the rib width W19 are different due to different sizes of the plurality of ribs 1202, 1204. Similarly, the plurality of grooves 1206 may or may not have different widths. Herein, the plurality of grooves 1206 may be defined by a groove width W20. A ratio of width of a large sized rib (biggest rib with width W19) to width of a small sized rib (smallest rib with width W18) may be 1.2 or more. The plurality of ribs 1202, 1204 may be discontinuous and parallel. The sheath 1200 and components of the sheath 1200 may have similar details/features/dimensions as explained above in conjunction with FIG. 1 and FIG. 2 and thus, details regarding the same are excluded herein for sake of brevity but should be understood and read in accordance with FIG. 1 and FIG. 2.

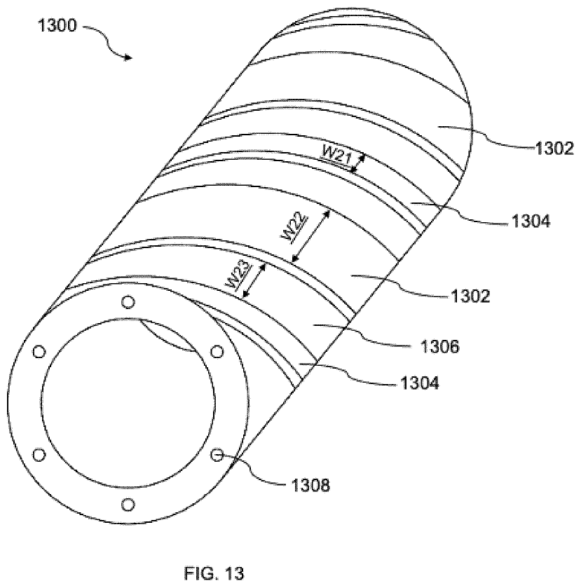

FIG. 13 illustrates an example design of a sheath 1300 of an optical fiber cable having continuous helical ribs. The sheath 1300 may have a plurality of ribs 1302, 1304 and a plurality of grooves 1306 formed helically and one or more strength members 1308. The plurality of ribs 1302, 1304 and the plurality of grooves 1306 may be formed in such a way that at least one groove has unequal groove width and/or at least one rib has unequal rib width. For example, ribs 1304 are small sized ribs having a rib width W21 (smaller width) and ribs 1302 are large sized ribs having a rib width W22 (larger width). As shown in FIG. 13, the rib width W21 and the rib width W22 are different due to different sizes of the plurality of ribs 1302, 1304.

Similarly, the plurality of grooves 1306 may or may not have different widths. Herein, the plurality of grooves 1306 may be defined by a groove width W23. A ratio of width of a large sized rib (biggest rib with width W22) to width of a small sized rib (smallest rib with width W21) may be 1.2 or more. The plurality of ribs 1302, 1304 may be continuous and parallel. The sheath 1300 and components of the sheath 1300 may have similar details/features/dimensions as explained above in conjunction with FIG. 1 and FIG. 2 and thus, details regarding the same are excluded herein for sake of brevity but should be understood and read in accordance with FIG. 1 and FIG. 2.

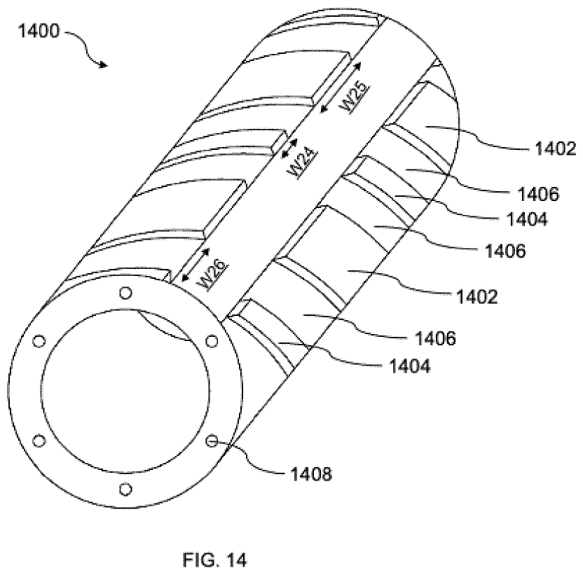

FIG. 14 illustrates an example design of a sheath 1400 of an optical fiber cable having discontinuous helical ribs. The sheath 1400 may have a plurality of ribs 1402, 1404 and a plurality of grooves 1406 formed helically and one or more strength members 1408. The plurality of ribs 1402, 1404 and the plurality of grooves 1406 may be formed in such a way that at least one groove has unequal groove width and/or at least one rib has unequal rib width. For example, ribs 1404 are small sized ribs having a rib width W24 (smaller width) and ribs 1402 are large sized ribs having a rib width W25 (larger width). As shown in FIG. 14, the rib width W24 and the rib width W25 are different due to different sizes of the plurality of ribs 1402, 1404. Similarly, the plurality of grooves 1406 may or may not have different widths. Herein, the plurality of grooves 1406 may be defined by a groove width W26. A ratio of width of a large sized rib (biggest rib with width W25) to width of a small sized rib (smallest rib with width W24) may be 1.2 or more. The plurality of ribs 1402, 1404 may be discontinuous and parallel. The sheath 1400 and components of the sheath 1400 may have similar details/features/dimensions as explained above in conjunction with FIG. 1 and FIG. 2 and thus, details regarding the same are excluded herein for sake of brevity but should be understood and read in accordance with FIG. 1 and FIG. 2.

Advantageously, the optical fiber cables with the sheaths having ribs and/or grooves along the periphery will blow better as compared to the conventional optical fiber cables having smooth sheaths. Due to the proposed concept of ribs and grooves, the weight of the optical fiber cables is reduced, resulting in lower frictional forces and higher drag forces that will make the blowing better. For example, the optical fiber cables proposed herein may be capable of being blown to a distance of at least 500 m in a duct with an average speed of at least 40 meter per minute blown with an air pressure of less than 15 bar with a duct fill ratio of 35% to 65%. Alternatively, values of the distance, average speed, air pressure and duct fill ratio may vary.

It may be noted that although the present disclosure proposes sheath designs for optical fiber cables, however the same sheath designs may be applicable to electric cables, composite cables, or other transmission cables.

The various actions, acts, blocks, steps, or the like may be performed in the order presented, in a different order or simultaneously. Further, in some embodiments, some of the actions, acts, blocks, steps, or the like may be omitted, added, modified, skipped, or the like without departing from the scope of the invention.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope of the invention. It is intended that the specification and examples be considered as exemplary, with the true scope of the invention being indicated by the claims.

Conditional language used herein, such as, among others, “can,” “may,” “might,” “may,” “e.g.,” and the like, unless specifically stated otherwise, or otherwise understood within the context as used, is generally intended to convey that certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

While the detailed description has shown, described, and pointed out novel features as applied to various alternatives, it can be understood that various omissions, substitutions, and changes in the form and details of the devices or algorithms illustrated can be made without departing from the scope of the disclosure. As can be recognized, certain alternatives described herein can be embodied within a form that does not provide all of the features and benefits set forth herein, as some features can be used or practiced separately from others.

We claim:

1. An optical fiber cable (100), comprising:
one or more optical transmission elements (118); and
a sheath (102) surrounding the one or more optical transmission elements (118), wherein an outer surface of the sheath (102) has a plurality of ribs (104, 106, 108) and a plurality of grooves (110, 112) such that at least one rib has unequal rib width or at least one groove has unequal groove width.

2. The optical fiber cable (100) as claimed in claim 1, wherein the plurality of ribs (104, 106, 108) is continuous and parallel on the outer surface.

3. The optical fiber cable (100) as claimed in claim 1, wherein the plurality of ribs (104, 106, 108) is discontinuous.

4. The optical fiber cable (100) as claimed in claim 1, wherein a rib width is measured at bottom and is greater than or equal to 0.15 mm.

5. The optical fiber cable (100) as claimed in claim 1, wherein a groove width is measured at top and is greater than or equal to 0.15 mm.

6. The optical fiber cable (100) as claimed in claim 1, wherein a rib height is greater than or equal to 0.15 mm, measured radially.

7. The optical fiber cable (100) as claimed in claim 1, wherein a ratio of width of a largest rib to width of a smallest rib and/or a ratio of width of a largest sized groove to width of a smallest sized groove is 1.2 or more.

8. The optical fiber cable (100) as claimed in claim 1, wherein the optical fiber cable (100) is capable of being blown to a distance of at least 500 m in a duct with an average speed of at least 40 meter per minute blown with an air pressure of less than 15 bar with a duct fill ratio of 35% to 65%.

9. The optical fiber cable (100) as claimed in claim 1, wherein the sheath (102) has a thickness of 1.5 mm to 3 mm including a rib height.

10. An optical fiber cable (100), comprising:
one or more optical transmission elements (118); and
a sheath (102) surrounding the one or more optical transmission elements (118), wherein a rib width is greater than or equal to 0.15 mm, measured at bottom, wherein a groove width is greater than or equal to 0.15 mm, measured at top, wherein a rib height is greater than or equal to 0.15 mm, measured radially.

11. The optical fiber cable (100) as claimed in claim 10, wherein an outer surface of the sheath (102) has a plurality of ribs (104, 106, 108) and a plurality of grooves (110, 112) such that at least one groove has unequal groove width.

12. The optical fiber cable (100) as claimed in claim 10, wherein an outer surface of the sheath (102) has a plurality of ribs (104, 106, 108) and a plurality of grooves (110, 112) such that at least one rib has unequal rib width.

13. The optical fiber cable (100) as claimed in claim 10, wherein the optical fiber cable (100) is capable of being blown to a distance of at least 500 m in a duct with an average speed of at least 40 meter per minute blown with an air pressure of less than 15 bar with a duct fill ratio of 35% to 65%.
